(19) United States
(12) Patent Application Publication
(10) Pub. No.: US 2008/0062119 A1
(43) Pub. Date: Mar. 13, 2008

(54) ELECTROPHORETIC DISPLAY AND METHOD OF MANUFACTURE

(76) Inventors: Jae-Byung Park, Seongnam-si (KR); Sung Jin Kim, Seongnam-si (KR)

Correspondence Address: MACPHERSON KWOK CHEN & HEID LLP, 2033 GATEWAY PLACE, SUITE 400, SAN JOSE, CA, 95110, US

(21) Appl. No.: 11/853,620

(22) Filed: Sep. 11, 2007

(30) Foreign Application Priority Data
Sep. 12, 2006 (KR) 10-2006-0088033

(51) Int. Cl. G09G 3/34

(52) U.S. Cl. 345/107

(57) ABSTRACT

An electrophoretic display and a method for more easily manufacturing the same which includes forming a thermal conversion film on a transfer substrate, forming a transfer film having an electrophoretic member dispersed therein on the thermal conversion film, preparing a first panel where a first electrode is formed and aligning the first panel and a transfer substrate, transferring a predetermined portion of the transfer film to the first electrode by a laser induced thermal imaging (LITI) method, and preparing a second panel where a second electrode is formed to align and tightly contact the second panel and the transfer film so that the second electrode and the transferred transfer film can correspond to each other.

### CROSS-REFERENCE TO RELATED APPLICATION

This application claims priority to and the benefit of Korean Patent Application No. 10-2006-0088033 filed in the Korean Intellectual Property Office on Sep. 12, 2006, the entire contents of which are incorporated herein by reference.

### BACKGROUND OF THE INVENTION

1. Field of the Invention

The present invention relates to an electrophoretic display and a method of manufacture.

2. Description of the Related Art

In the electrophoretic display, the voltage applied between the pixel electrodes and a common electrode rotates or moves the positively or negatively charged and colored electrophoretic particles closer to one or the other of the electrodes.

In manufacturing an electrophoretic display, an electrophoretic member is provided including electrophoretic particles and a microcapsule that encloses a dispersion medium having electrophoretic particles dispersed therein. Then, a binder is coated on either pixel electrodes of a first panel or a common electrode of a second panel and an electrophoretic member is deposited on the coated binder, or a binder having the electrophoretic member dispersed therein is coated thereon. Then, the binder is hardened to fix the electrophoretic member to the pixel electrodes or the common electrode. Afterwards, a process of tightly contacting a second panel or first panel is performed so that the unattached common electrode or pixel electrodes are positioned on the attached and fixed electrophoretic member.

However, the process of attaching an electrophoretic member to pixel electrodes or a common electrode by using a binder is complicated, and it is not easy to precisely coat the binder at a desired portion of the pixel electrodes or common electrode and attach the electrophoretic member, thereby degrading the display performance of the manufactured electrophoretic display.

### SUMMARY OF THE INVENTION

In accordance with an aspect of the present invention, a more easily manufactured electrophoretic display having improved display performance comprises: an electrophoretic unit positioned between a first electrode and a second electrode and which may be attached to either electrode using laser induced thermal imaging (LITI). An electrophoretic member includes white and black electrophoretic particles, a dispersion medium having the colored electrophoretic particles dispersed therein, and a capsule enclosing the electrophoretic particles and the dispersion medium.

The electrophoretic member may include electrophoretic particles having at least one of red, green, blue, yellow, magenta, or cyan colors; a dispersion medium having the electrophoretic particles dispersed therein; and a capsule enclosing the electrophoretic particles and the dispersion medium.

The electrophoretic member may further include additional electrophoretic particles that are dispersed in the dispersion medium and having a black color.

The transfer film may be an organic film having an ultraviolet hardener.

The first electrode may be a common electrode, and the second electrode may be a pixel electrode.

A method of manufacturing an electrophoretic display according to the present invention, comprises: forming a thermal conversion film on a transfer substrate; forming a transfer film having an electrophoretic member dispersed therein on the thermal conversion film; preparing a first panel where a first electrode is formed and aligning the first panel and a transfer substrate; transferring a predetermined portion of the transfer film to the first electrode by a laser induced thermal imaging (LITI) method; and preparing a second panel where a second electrode is formed to align and tightly contact the second panel and the transfer film so that the second electrode and the transferred transfer film can correspond to each other.

Forming of the transfer film may include coating a transfer film forming material having an electrophoretic member dispersed therein on the transfer substrate, and hardening the coated transfer film forming material.

The hardening of the predetermined transferred portion of the transfer film may be performed by ultraviolet hardening.

The method may further include, between the transferring of a predetermined portion of the transfer film to the first electrode and the preparing a second panel where a second electrode is formed to align and tightly contact the second panel and the transfer film, hardening of the predetermined transferred portion of the transfer film.

The hardening of the predetermined transferred portion of the transfer film may be performed by ultraviolet hardening.

The laser used in the laser induced thermal imaging (LITI) method may be an infrared ray laser.

The infrared ray laser may have a wavelength from 760 nm to 1200 nm.

The electrophoretic member may include first electrophoretic particles having a white color, second electrophoretic particles having a black color, a dispersion medium having the first and second electrophoretic particles dispersed therein, and a capsule enclosing the first and second electrophoretic particles and the dispersion medium.

The electrophoretic member may include electrophoretic particles having at least one of red, green, blue yellow, magenta, or cyan colors; a dispersion medium having the electrophoretic particles dispersed therein; and a capsule enclosing the electrophoretic particles and the dispersion medium.

The electrophoretic member may further include additional electrophoretic particles that are dispersed in the dispersion medium and having a black color.

The transfer substrate may include first to third transfer substrates, and the forming of the transfer film may include: forming a first transfer film on a thermal conversion film formed on the first transfer substrate, the first transfer film having an electrophoretic member including first electrophoretic particles having a red color dispersed and fixed thereon; forming a second transfer film on a thermal conversion film formed on the second transfer substrate, the second transfer film having an electrophoretic member including first electrophoretic particles having a green color dispersed and fixed thereon; and forming a third transfer film on a thermal conversion film formed on the third transfer substrate, the third transfer film having an electrophoretic member including third electrophoretic particles having a blue color dispersed and fixed thereon.

The transfer substrate may include first to third transfer substrates, and the forming of the transfer film may include: forming a first transfer film on a thermal conversion film formed on the first transfer substrate, the first transfer film having an electrophoretic member including first electrophoretic particles having a yellow color dispersed and fixed thereon; forming a second transfer film on a thermal conversion film formed on the second transfer substrate, the second transfer film having an electrophoretic member including first electrophoretic particles having a magenta color dispersed and fixed thereon; and forming a third transfer film on a thermal conversion film formed on the third transfer substrate, the third transfer film having an electrophoretic member including third electrophoretic particles having a cyan color dispersed and fixed thereon.

The aligning of the transfer substrate and the first panel may include aligning the first panel and the first transfer substrate, aligning the first panel and the second transfer substrate, and aligning the first panel and the third transfer substrate.

The transferring of a predetermined portion of the transfer film on the first electrode may include transferring a predetermined portion of the first transfer film to a corresponding portion of the first electrode, transferring a predetermined portion of the second transfer film to a corresponding portion of the first electrode so as to be adjacent to the predetermined transferred portion of the first transfer film, and transferring a predetermined portion of the second transfer film to a corresponding portion of the first electrode so as to be adjacent to the predetermined transferred portion of the second transfer film.

The first electrode may be a common electrode, and the second electrode may be a pixel electrode.

The first electrode may be a pixel electrode, and the second electrode may be a common electrode.

### BRIEF DESCRIPTION OF THE DRAWINGS

FIG. 1 is a layout view illustrating a structure of an electrophoretic display according to an exemplary embodiment of the present invention,

FIG. 2 is a cross-sectional view taken along line II-II′ of the electrophoretic device of FIG. 1,

FIG. 3 is a cross-sectional view illustrating three pixel areas of an electrophoretic display according to one exemplary embodiment of the present invention,

FIGS. 4A to 4J are cross-sectional views sequentially illustrating a method for manufacturing an electrophoretic display according to one exemplary embodiment of the present invention,

FIG. 5 is a cross-sectional view illustrating another method for manufacturing an electrophoretic display according to one exemplary embodiment of the present invention,

FIG. 6 is a cross-sectional view showing three pixel areas of an electrophoretic display according to another exemplary embodiment of the present invention, and

FIGS. 7 and 8 are cross-sectional views sequentially illustrating a method for manufacturing an electrophoretic display according to another exemplary embodiment of the present invention.

### DETAILED DESCRIPTION OF THE EMBODIMENTS

Hereinafter, the present invention will be described more fully hereinafter with reference to the accompanying drawings, in which exemplary embodiments of the invention are shown. In the drawings, the thickness of layers, films, panels, regions, etc., are exaggerated for clarity. It will be understood that when an element such as a layer, film, region, or substrate is referred to as being “on” another element, it can be directly on the other element or intervening elements may also be present. In contrast, when an element is referred to as being “directly on” another element, there are no intervening elements present.

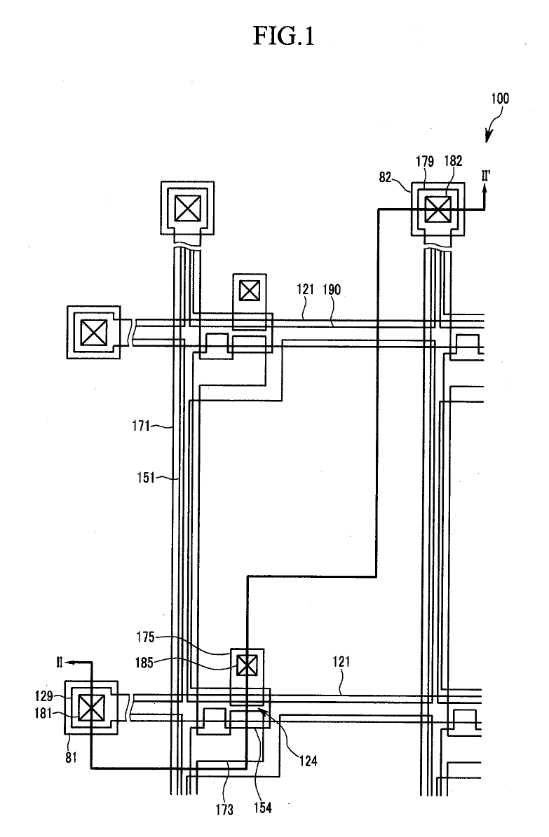

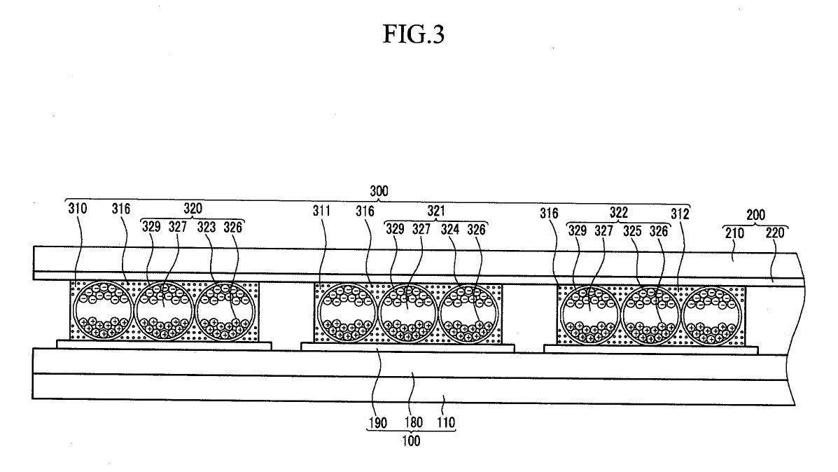

First, an electrophoretic display according to one exemplary embodiment of the present invention will be described in detail with reference to FIGS. 1 and 3.

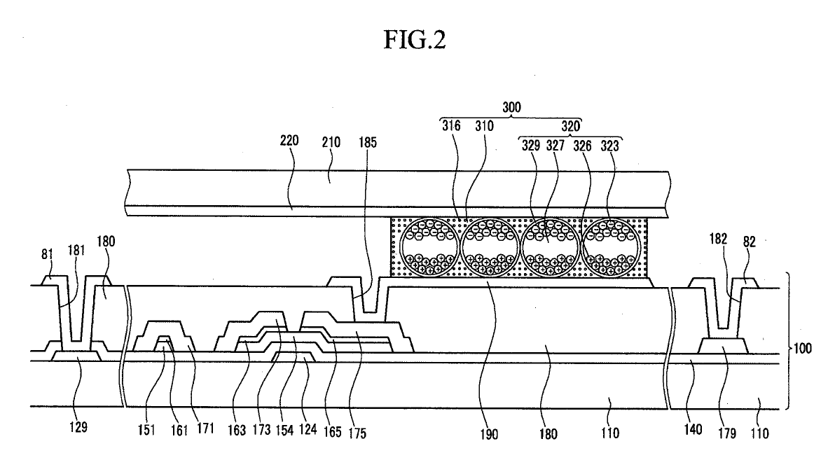

FIG. 1 is a layout view illustrating a structure of an electrophoretic display according to an exemplary embodiment of the present invention, FIG. 2 is a cross-sectional view taken along line II-II′ of the electrophoretic device of FIG. 1, and FIG. 3 is a cross-sectional view illustrating three pixel areas of an electrophoretic display according to one exemplary embodiment of the present invention.

The electrophoretic display according to one exemplary embodiment of the present invention includes a thin film transistor array panel 100, a common electrode panel 200 facing the thin film transistor array panel 100, and an electrophoretic unit 300 positioned between the panels 100 and 200 and formed by a laser induced thermal imaging (LITI) method.

First, the thin film transistor array panel 100 will be described.

As shown in FIGS. 1 and 3, a plurality of gate lines 121 transmitting gate signals are formed on an insulation substrate 110 made of transparent glass or the like. The gate lines 121 extends substantially in a transverse direction, and each gate line 121 includes a plurality of gate electrodes 124 and an extended end portion 129 for contact with another layer or an external device.

The gate lines 121 are preferably made of aluminum-containing metals such as aluminum (Al) and aluminum alloys, silver containing metals such as silver (Ag) and silver alloys, copper containing metals such as copper (Cu) and copper alloys, molybdenum containing metals such as molybdenum (Mo) and molybdenum alloys, chromium (Cr), titanium (Ti), tantalum (Ta), and so forth. The gate line 121 includes two films having different physical characteristics, i.e., a lower film (not shown) and an upper film (not shown). The upper film is preferably made of a low resistivity metal including an Al-containing metal such as Al and an Al alloy for reducing signal delay or voltage drop in the gate lines 121. On the other hand, the lower film is preferably made of a material such as Mo, a Mo alloy, and Cr, which has good contact characteristics with other materials such as indium tin oxide (ITO) and indium zinc oxide (IZO). Good examples of combination of the lower film material and the upper film material are Cr and Al—Nd alloy.

The gate lines 121 have either a single-layered structure or a triple-layered structure.

A gate insulating layer 140 preferably made of silicon nitride (SiNx) is formed on the gate lines 121.

A plurality of semiconductor stripes 151 preferably made of hydrogenated amorphous silicon is formed on the gate insulating layer 140. Each semiconductor stripe 151 extends substantially in the longitudinal direction and has a plurality of projections 154 branched out toward the gate electrodes 124. The width of each semiconductor stripe 151 becomes large near the gate lines 121 such that the semiconductor stripe 151 covers large areas of the gate lines 121.

A plurality of ohmic contact stripes and islands 161 and 165 preferably made of silicide or n+ hydrogenated a-Si heavily doped with an n-type impurity are formed on the semiconductor stripes 151. Each ohmic contact stripe 161 has a plurality of projections 163, and the projections 163 and the ohmic contact islands 165 are located in pairs on the projections 154 of the semiconductor stripes 151.

A plurality of data lines 171 and a plurality of drain electrodes 175 are formed on the ohmic contacts 161 and 165 and the gate insulating layer 140, respectively.

The data lines 171 for transmitting data voltages extend substantially in the longitudinal direction and intersect the gate lines 121. Each data line 171 includes a plurality of source electrodes 173 projecting toward the gate electrodes 124 and curved like a character “J”, and an extended end portion 179 having a larger area for contact with another layer or an external device. Each pair of the source electrodes 173 and the drain electrodes 175 are separated from each other and opposite each other with respect to a gate electrode 124.

The data lines 171 and the drain electrodes 175 are preferably made of a refractory metal such as Cr, a Mo-containing metal, Ta, and Ti, and may have a multi-layered structure including a lower film (not shown) made of Mo, a Mo alloy, or Cr and an upper film (not shown) located thereon and made of an Al-containing metal.

A gate electrode 124, a source electrode 173, and a drain electrode 175 along with a projection 154 of a semiconductor stripe 151 form a TFT having a channel formed in the projection 154 disposed between the source electrode 173 and the drain electrode 175.

The ohmic contacts 161 and 165 are interposed between the underlying semiconductor stripes 151 and the overlying data lines 171 and the overlying drain electrodes 175 thereon and reduce the contact resistance therebetween.

The semiconductor stripes 151 include a plurality of exposed portions, which are not covered with the data lines 171 and the drain electrodes 175, such as portions located between the source electrodes 173 and the drain electrodes 175. Although the semiconductor stripes 151 are narrower than the data lines 171 at most places, the width of the semiconductor stripes 151 becomes large near the gate lines as described above, to enhance the insulation between the gate lines 121 and the data lines 171.

A passivation layer 180 is formed in a single-layered or multi-layered structure on the data lines 171 and 172, the drain electrodes 175, the storage conductors 177, and the exposed portions of the semiconductor stripes 151. The passivation layer 180 is preferably made of a photosensitive organic material having a good flatness characteristic, a low dielectric insulating material such as a-Si:C:O and a-Si:O:F formed by plasma enhanced chemical vapor deposition (PECVD), or an inorganic material such as silicon nitride. For example, if the passivation layer 180 is formed of an organic material, to prevent the organic material of the passivation layer 180 from contacting with the semiconductor strips 151 exposed between the data line 171 and the drain electrode 175, the passivation layer 180 can be structured in such a way that an insulating layer (not shown) made of SiNx or SiO₂ is additionally formed under the organic material layer.

The passivation layer 180 has a plurality of contact holes 181, 185, and 182 exposing the end portions 129 of the gate lines 121 and the end portions 179 of the drain electrodes 175 and the data lines 171, respectively.

A plurality of pixel electrodes 190 and a plurality of contact assistants 81 and 82, which are preferably made of ITO or IZO, are formed on the passivation layer 180.

The pixel electrodes 190 are physically and electrically connected to the drain electrodes 175 through the contact holes 185 such that the pixel electrodes 190 receive the data voltages from the drain electrodes 175 to apply a data voltage to respective electrophoretic members 320, 321, and 322.

The contact assistants 81/82 are connected to the exposed end portions 129/179 of the gate lines 121/the data lines 171 through the contact holes 181/182. The contact assistants 81 and 82 protect the exposed portions of the gate lines 121 and the data lines 171 and complement the adhesion between the exposed portions and external devices such as a driving integrated circuit.

Next, an electrophoretic unit 300 will be described.

The electrophoretic unit 300 includes transfer films 310, 311, and 312 formed on respective pixel electrodes 190 by a laser induced thermal imaging (LITI) method, and electrophoretic members 320, 321, and 322 dispersed and fixed in the respective transfer films 310, 311, and 312.

The transfer film 310, 311, and 312 include a first transfer film 310, a second transfer film 311, and a third transfer film 312 that are disposed alternately and repeatedly, and are made of organic films containing an ultraviolet hardener 316.

The electrophoretic member 320, 321, and 322 include a first electrophoretic member 320, a second electrophoretic member 321, and a third electrophoretic member 322 that are disposed alternately and repeatedly on a plurality of different pixel electrodes 190.

The first electrophoretic member 320 that is dispersed and fixed in the first transfer film 310 includes red electrophoretic particles 323, black electrophoretic particles 326, and a dispersion medium 327, and a capsule 329 enclosing them.

The red electrophoretic particles 323 are electrification particles that show a red color and have negative charges.

The black electrophoretic particles 326 are electrification particles that show a black color and have positive charges.

The red electrophoretic particles 323 and black electrophoretic particles 326 may have positive charges and negative charges, respectively, contrary to the above.

The second electrophoretic member 321 that is dispersed and fixed in the second transfer film 311 and the third electrophoretic member 322 that is dispersed and fixed in the third transfer film 312 are the same as the first electrophoretic member 320, except that they include green electrophoretic particles 324 and blue electrophoretic particles 325, respectively, instead of red electrophoretic particles 323.

The green electrophoretic particles 324 are electrification particles that show a green color and have negative charges. The blue electrophoretic particles 325 are electrification particles that show a blue color and have negative charges.

The green electrophoretic particle 324 and black electrophoretic particles 326 of the second electrophoretic member 321 may have positive charges and negative charges, respectively, contrary to the above. The blue electrophoretic particles 325 and black electrophoretic particles 326 of the third electrophoretic member 322 may have positive charges and negative charge, respectively, as above.

Meanwhile, the red electrophoretic particles 323, green electrophoretic particles 324, and blue electrophoretic particles 325 may be replaced with electrophoretic particles having a yellow color, electrophoretic particles having a magenta color, and electrophoretic particles having a cyan color.

The dispersion medium 327 may disperse the respective electrophoretic particles 323, 324, 325, and 326, and have a transparent or black color. If the dispersion medium 327 has a black color, the black electrophoretic particles 326 contained in the respective electrophoretic particles 320, 321, and 322 may be omitted since the black color can be represented by using the dispersion medium 327.

The capsule 329 encloses the respective electrophoretic particles 323, 324, 325, and 326 and the dispersion medium 327, and accordingly, the respective electrophoretic particles 323, 324, 325, and 326 are movable for color representation only within the capsule 329.

Next, the common electrode panel 200 will be described.

The common electrode panel 200 is formed on the electrophoretic unit 300, and includes an insulation substrate 210 and a common electrode 220 formed on the insulation substrate 210.

The common electrode 220 is a transparent electrode made of ITO or IZO, and it applies a common voltage to the respective electrophoretic members 320, 321, and 322.

The common electrode 220 applying a common voltage generates an electric field in the respective electrophoretic members 320, 321, and 322 along with the pixel electrodes 190 applying a data voltage. The generated electric field changes the position of the electrophoretic particles 323, 324, 325, and 326 of the respective electrophoretic member 320, 321, and 322 dispersed and fixed by the respective transfer film 310, 311, and 312, thereby displaying an image of a desired color.

Hereinafter, a method for displaying images of various colors by an electrophoretic display according to one exemplary embodiment of the present invention will be concretely described.

The application of a negative voltage to the pixel electrodes 190 via the drain electrode 175 of the electrophoretic display and a positive voltage is applied to the common electrode 220 will now be described. The red, green, and blue electrophoretic particles 323, 324, and 325 are irregularly dispersed in the dispersion medium 327 within the capsule 329 and having negative charges are moved to the common electrode 220 having a positive voltage applied thereto, and arranged thereon. Meanwhile, the black electrophoretic particles 326 having positive charges are moved to the pixel electrodes 190 having a negative voltage applied thereto, and arranged thereon. By this arrangement, an external light incident through the common electrode panel 200 is reflected by the respective electrophoretic particles 323, 324, and 325, thereby displaying each of the colors represented by the respective electrophoretic particles 323, 324, and 325. At this time, white color is displayed by additive color mixing of each of the colors displayed by the red, green, and blue electrophoretic particles 323, 324, and 325.

The application of a positive voltage to the pixel electrodes 190 via the drain electrode 175 of the electrophoretic display and a negative voltage is applied to the common electrode 220 will now be described.

The red, green, and blue electrophoretic particles 323, 324, and 325 are irregularly dispersed in the dispersion medium 327 and, having negative charges are moved to the pixel electrodes 190 having a positive voltage applied thereto, and arranged thereon. Meanwhile, the black electrophoretic particles 326 having positive charges are moved to the common electrode 220 having a negative voltage applied thereto, and arranged thereon.

By this arrangement, an external light incident through the common electrode panel 200 from the outside is absorbed by the black color electrophoretic particles 326, thereby displaying black color.

Meanwhile, each pixel electrode 190 can apply a positive or negative voltage of a different magnitude, so that the arrangement of the respective electrophoretic particles 323, 324, 325, and 326 can be varied according to each pixel electrode 190. This enables the representation of a desired color.

Hereinafter, a method for manufacturing an electrophoretic display according to one exemplary embodiment of the present invention will be described in detail with reference to FIGS. 1 to 3 and FIGS. 4A to 4J.

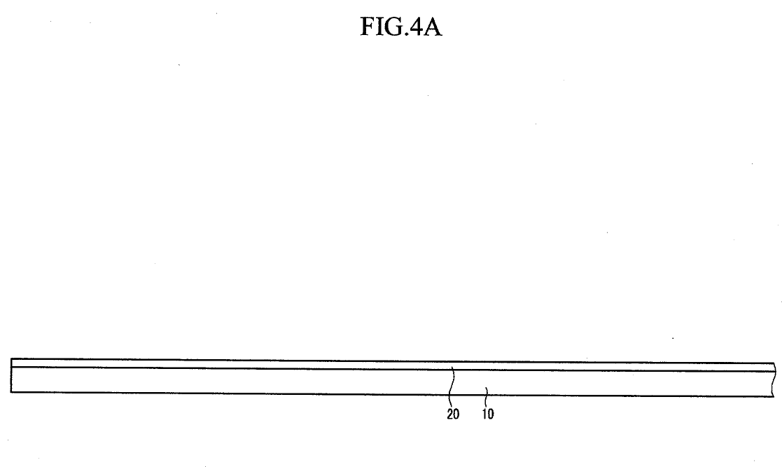

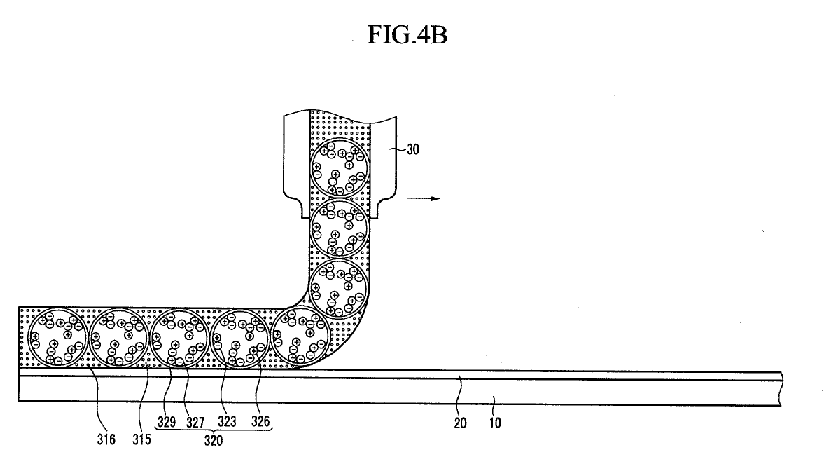

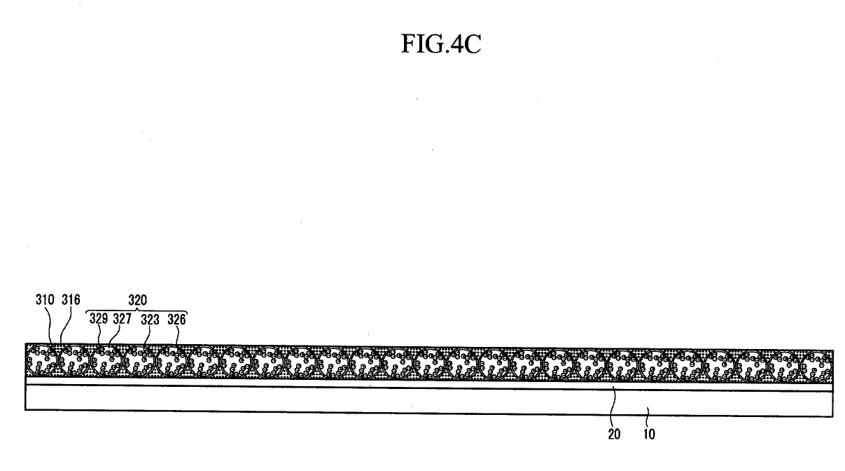

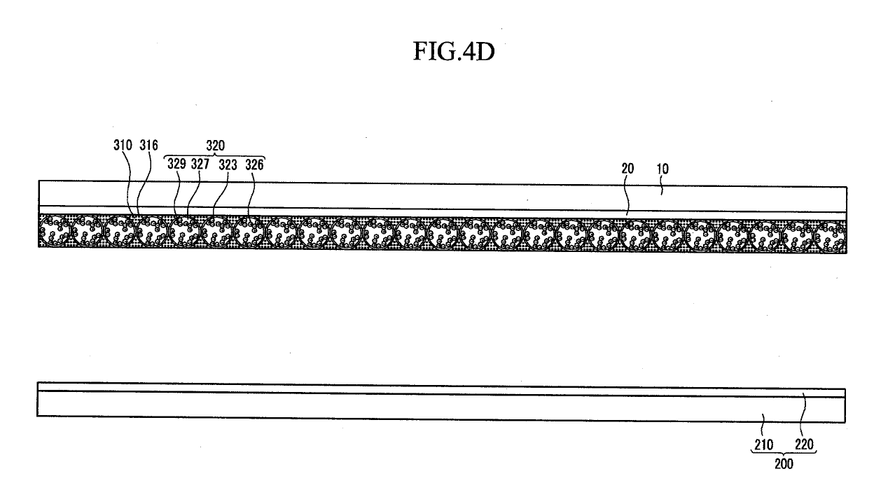

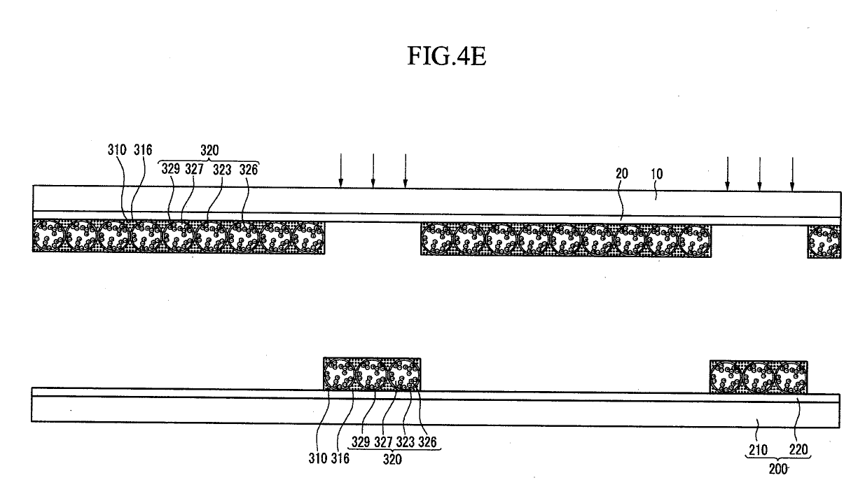

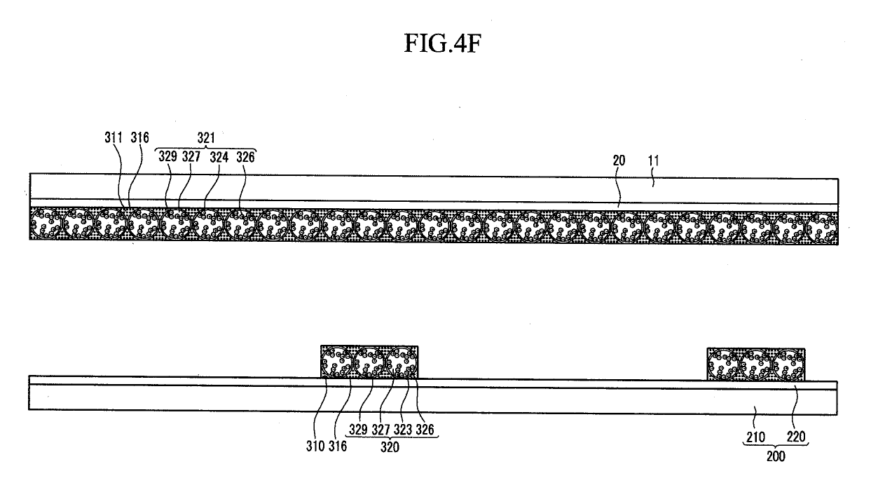

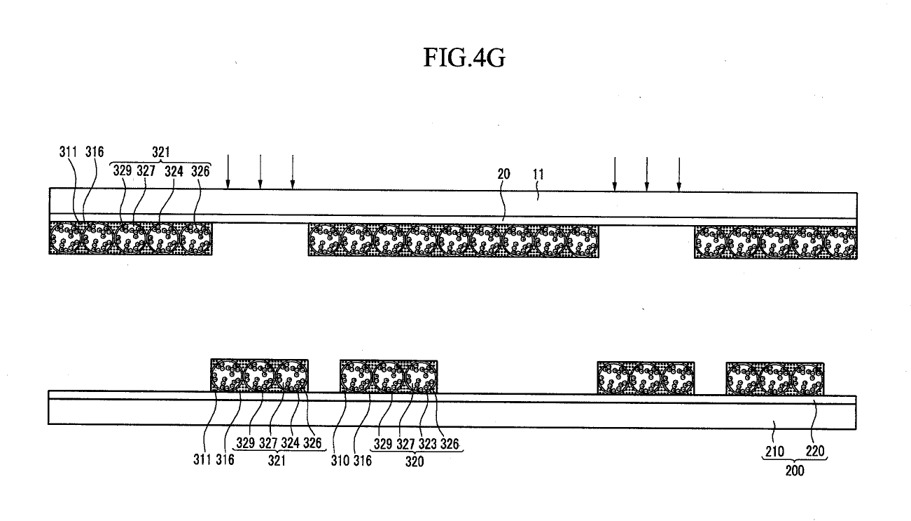

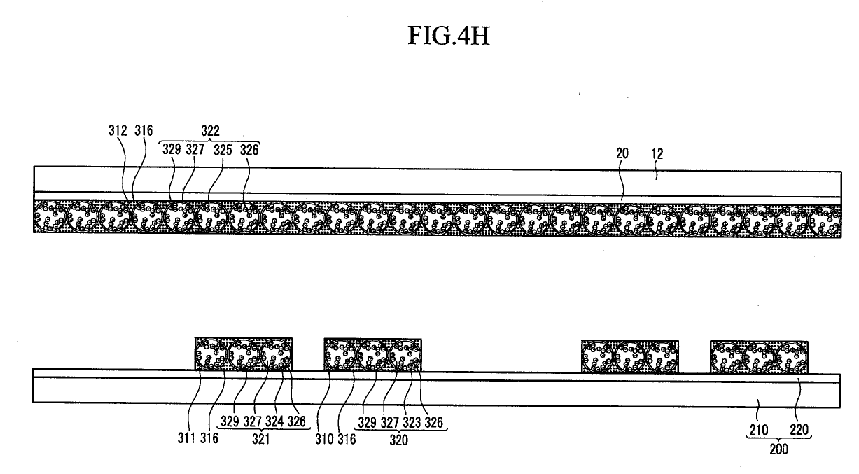

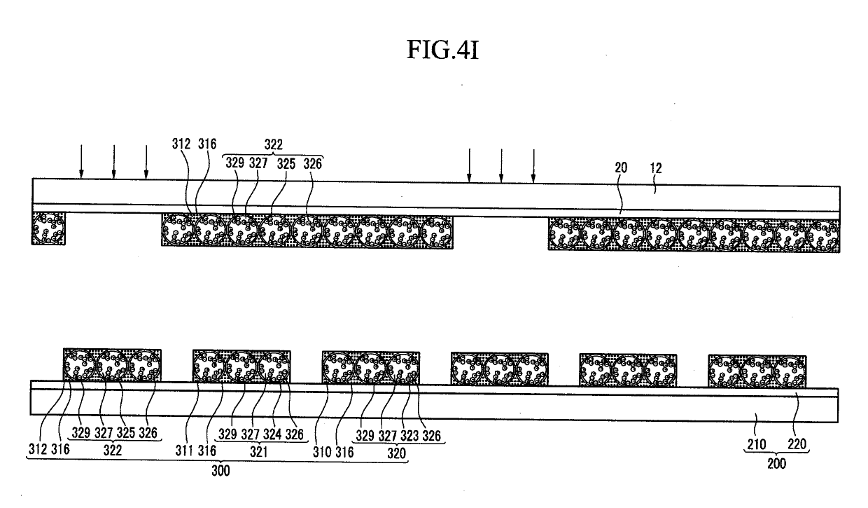

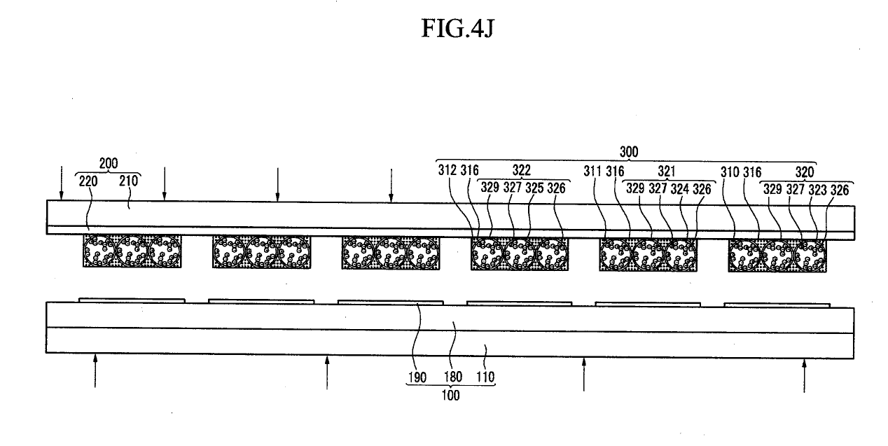

FIGS. 4A to 4J are cross-sectional views sequentially illustrating a method for manufacturing an electrophoretic display according to one exemplary embodiment of the present invention.

First, as shown in FIG. 4A, a thermal conversion film 20 is formed on a first transfer substrate 10. In addition, a thermal conversion film 20 is formed on a second transfer substrate (corresponding to 11 of FIG. 4F) and on a third transfer substrate (corresponding to 12 of FIG. 4H), respectively.

Here, the respective substrates 10, 11, and 12 are insulation substrates made of transparent glass or plastic.

The thermal conversion film 20 changes light energy of a laser irradiated to each of the transfer substrates 10, 11, and 12 into thermal energy, and supplies the thermal energy to some parts of the respective transfer films 310, 311, and 312. Accordingly, the parts of the transfer films 310, 311, and 312 having received the thermal energy are made movable by the supplied heat and are transferred to the common electrode panel 200.

The thermal conversion film 20 may be an organic material, such as phthalocyanine or naphthalocyanine, which is formed by coating. The thermal conversion film 20 is formed by deposition, and may include a blackened metal such as Ag.

Then, as shown in FIG. 4B, a first electrophoretic member 320 including the red and black electrophoretic particles 323 and 326 and a transfer film forming material 315 of a liquid or gel state having an ultraviolet hardener 316 dispersed therein are coated on the thermal conversion film 20 formed on the first transfer substrate 10 by using a coating member 30.

n the same manner, a second electrophoretic member 321 including the green and black electrophoretic particles 324 and 326 and a transfer film forming material 315 of a liquid or gel state having an ultraviolet hardener 316 dispersed therein are coated on the thermal conversion film 20 formed on the second transfer substrate 11 by using a coating member 30.

Additionally, a third electrophoretic member 322 including the blue and black electrophoretic particles 325 and 326 and a transfer film forming material 315 of a liquid or gel state having an ultraviolet hardener 316 dispersed therein are coated on the thermal conversion film 20 formed on the third transfer substrate 12 by using a coating member 30.

Then, as shown in FIG. 4C, the transfer film forming material 315 of a liquid or gel state coated on the first transfer substrate 10 is hardened by using ultraviolet rays, thereby forming the first transfer film 310 that is hardened.

In the same manner, the transfer film forming material 315 of a liquid or gel state coated on the second transfer substrate 11 and the third transfer substrate 12 are hardened by using ultraviolet rays, thereby forming the second electrophoretic film 311 (refer to FIG. 4F) and the third transfer film 312 (refer to FIG. 4H) that are hardened.

The hardening of the respective transfer films 310, 311, and 312 is also enabled by drying.

Then, as shown in FIG. 4D, a common electrode panel 200 where the common electrode 220 is formed is prepared, then the first transfer substrate 10 is aligned on the common electrode panel 200 so that the common electrode 220 and the first transfer film 310 can face each other, and then as shown in FIG. 4E, a predetermined portion of the first transfer film 310 is transferred to a corresponding portion of the common electrode 220 by a laser induced thermal imaging (LITI) method.

The corresponding portion of the common electrode 220 is also a portion that corresponds to the pixel electrode, where the first electrophoretic member 320 is positioned, among the plurality of pixel electrodes 190 facing the common electrode 220 by a subsequent process.

A process of transferring a predetermined portion of the first transfer film 310 to the corresponding portion of the common electrode 220 by a laser induced thermal imaging (LITI) method will be described in detail.

First, a laser is irradiated toward the predetermined portion of the first transfer film 310 from the top part of the common electrode panel 200 by using a laser irradiation member (not shown). The laser irradiated by the laser irradiation member (not shown) is preferably, though is not limited to, an infrared laser having a wavelength from 760 nm to 1200 nm determined by taking the strength and irradiation time of the energy and so on into account.

The laser irradiated toward the predetermined portion of the first transfer film 310 passes through the first transfer substrate 10, which is transparent, and then is irradiated to a predetermined portion of the thermal conversion film 20. The predetermined portion of the thermal conversion film 20 to which the laser is irradiated converts light energy of the laser into thermal energy to thus supply the converted thermal energy to the predetermined portion of the first transfer film 310. Accordingly, the corresponding portion of the first transfer film 310 that has received heat from the predetermined portion of the thermal conversion film 20 is made movable, unlike other portions of the first transfer film 310 that maintain a hardened state, and falls off downward, to thus be transferred to a predetermined portion of the common electrode 220. Since the first transfer film 310 being transferred includes the first electrophoretic member 320, the first electrophoretic member 320 is also transferred to the predetermined portion of the common electrode 220.

Then, the first electrophoretic member 320 that is capable of representing a red or black color is attached to the predetermined portion of the common electrode 220 by irradiating ultraviolet rays to the transferred predetermined portion of the first transfer film 310 for hardening the same. The hardening of the transferred predetermined portion of the first transfer film 310 can be performed by drying without using ultraviolet rays.

Thereafter, as shown in FIG. 4F, the second transfer substrate 11 is aligned on the common electrode panel 200 so that the common electrode 220 and the second transfer film 311 face each other, and then as shown in FIG. 4G, a predetermined portion of the second transfer film 311 is transferred to a predetermined portion of the common electrode 220 and hardened so as to be adjacent to a predetermined portion of the first transfer film 310. Subsequently, the second electrophoretic member 321 adjacent to the first electrophoretic member 320 is attached to the predetermined portion of the common electrode 220.

Then, as shown in FIG. 4H, the third transfer substrate 12 is aligned on the common electrode panel 200 so that the common electrode 220 and the third transfer film 312 face each other, and then as shown in FIG. 4I, a predetermined portion of the third transfer substrate 312 is transferred to a predetermined portion of the common electrode 220 and hardened by laser induced thermal imaging (LITI) method so as to be adjacent to the transferred predetermined portion of the first transfer film 310 and the transferred predetermined portion of the second transfer film 311), respectively. Subsequently, the third electrophoretic member 322 adjacent to the first electrophoretic member 320 and second electrophoretic member 321, respectively, is attached to the predetermined portion of the common electrode 220. As a result, the electrophoretic unit 300 is completed.

Thereafter, as shown in FIG. 4J, a thin film transistor panel 100 manufactured by a well-known method is prepared, and both of the panels 100 and 200 are aligned and pressurized to each other, so that any one of the first to third transfer films 310, 311, and 312 corresponds to each pixel electrode 190. By tightly contacting each pixel electrode 190 and any one of the first to third transfer films 310, 311, and 312 by pressurization, the electrophoretic display according to one exemplary embodiment of the present invention as shown in FIGS. 1 to 3 is completed.

According to a method for manufacturing of an electrophoretic display according to one exemplary embodiment, electrophoretic members 320, 321, and 322 can be easily formed between each pixel electrode 190 and the common electrode by a laser induced thermal imaging (LITI) method. Accordingly, the manufacturing efficiency and manufacturing accuracy of the electrophoretic display can be improved. Further, an electrophoretic display having excellent manufacturing efficiency and display performance is provided.

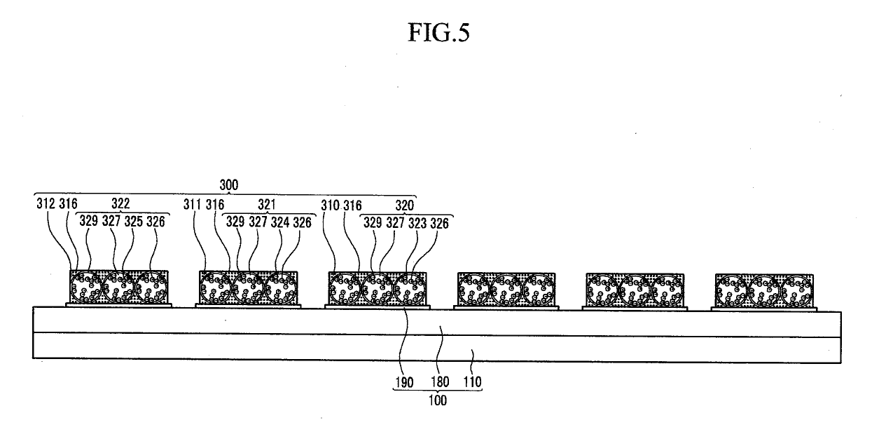

Hereinafter, another method for manufacturing an electrophoretic display according to an exemplary embodiment of the present invention will be described in detail with reference to FIG. 5.

FIG. 5 is a cross-sectional view illustrating another method for manufacturing an electrophoretic display according to one exemplary embodiment of the present invention.

The method for manufacturing an electrophoretic display according to the exemplary embodiment of the present invention as shown in FIG. 5 is the same as the method for manufacturing an electrophoretic display according to the exemplary embodiment of the present invention as shown in FIGS. 4A to 4J, except that any one of first to third transfer films 310, 311, and 312 is transferred to each pixel electrode 190 of a thin film transistor array panel 100, rather than to a common electrode, by a laser induced thermal imaging (LITI) method, and the transferred first to third electrode films 310, 311, and 312 and the common electrode 220 are tightly contacted with each other.

The method for manufacturing an electrophoretic display according to the exemplary embodiment of the present invention as shown in FIG. 5 can achieve the same effect as the method for manufacturing an electrophoretic display according to the exemplary embodiment of the present invention as shown in FIGS. 4A to 4J.

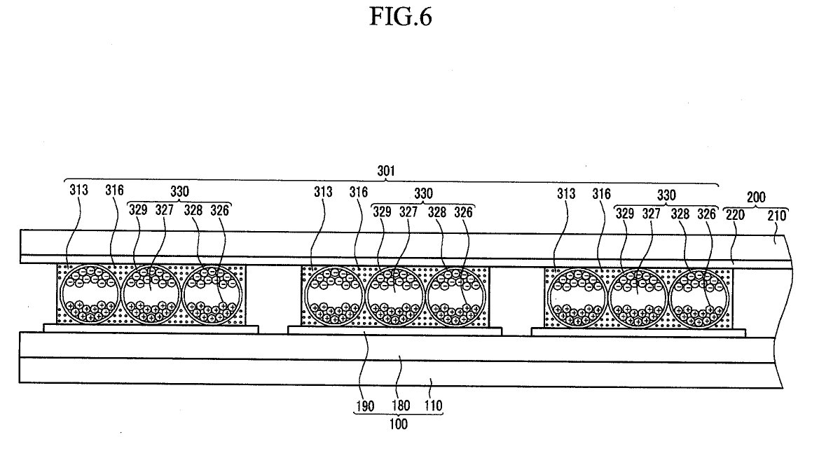

Hereinafter, an electrophoretic display according to a further exemplary embodiment of the present invention will be described with reference to FIG. 6. FIG. 6 is a cross-sectional view showing three pixel areas of an electrophoretic display according to another exemplary embodiment of the present invention.

The electrophoretic display according to the current exemplary embodiment of the present invention is the same as the electrophoretic display according to the exemplary embodiment of the present invention as shown in FIGS. 1 to 3, except that an electrophoretic member 330 of an electrophoretic unit 301 includes white color electrophoretic particles 328 displaying a white color and black electrophoretic particles 326 displaying a black color.

Therefore, the electrophoretic display according to the current exemplary embodiment of the present invention can represent only white and black colors, unlike the electrophoretic display as shown in the previous exemplary embodiments of the present invention.

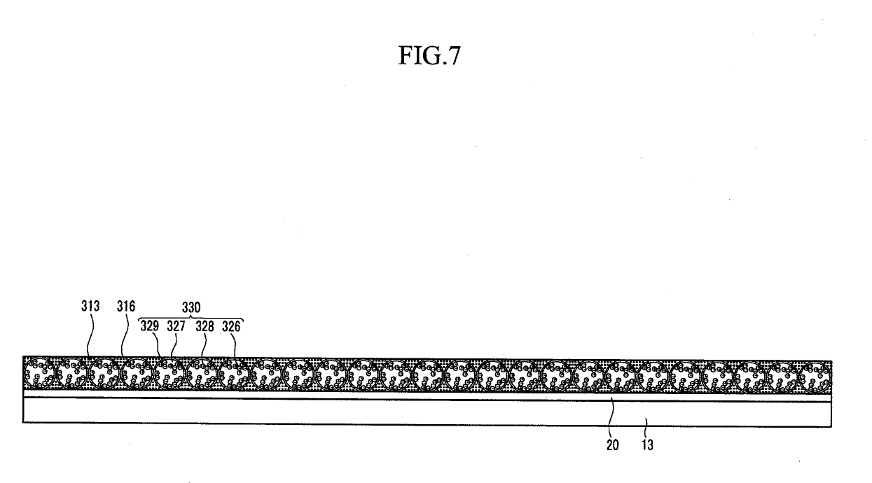

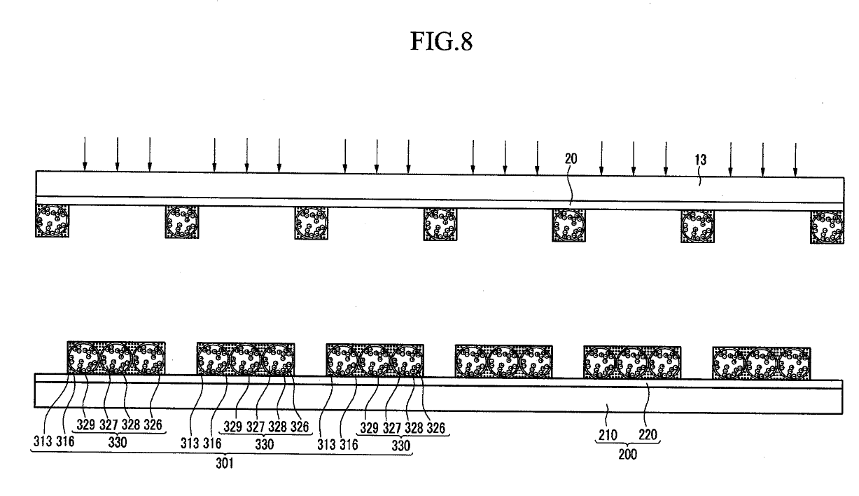

Hereinafter, a method for manufacturing an electrophoretic display according to another exemplary embodiment of the present invention will be described with reference to FIGS. 7 and 8.

FIGS. 7 and 8 are cross-sectional views sequentially illustrating a method for manufacturing an electrophoretic display according to another exemplary embodiment of the present invention.

In the electrophoretic display according to the current exemplary embodiment of the present invention, as explained above, the electrophoretic member 330 of the electrophoretic unit 301 includes white electrophoretic particles 328 displaying a white color and black electrophoretic particles 326 displaying a black color. Accordingly, the manufacturing method is implemented by forming a thermal conversion film 20 only on one transfer substrate 13 and forming a transfer film 313 for dispersing and fixing the electrophoretic member 330 on the thermal conversion film 20 by a coating and hardening process.

Then, as shown in FIG. 8, a predetermined portion of the transfer film 313 formed on the transfer substrate 13 by a laser induced thermal imaging (LITI) method is transferred to a corresponding portion of the common electrode 220 by performing a transfer process once.

The electrophoretic display and the method for manufacturing thereof according to the current exemplary embodiment can achieve the same effect as the electrophoretic display and the method for manufacturing thereof according to the previous exemplary embodiments of the present invention.

As above, according to the present invention, an electrophoretic display having excellent manufacturing efficiency, and display performance and a method for manufacturing thereof are provided.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An electrophoretic display, comprising:
a first panel including a first electrode;
a second panel including a second electrode facing the first electrode; and
an electrophoretic unit positioned between the first electrode and the second electrode and attached to the first electrode or the second electrode by laser induced thermal imaging (LITI), and including an electrophoretic member and a transfer film to disperse and fix the electrophoretic member.

2. The electrophoretic display of claim 1, wherein the electrophoretic member comprises:
first electrophoretic particles having a white color;
second electrophoretic particles having a black color;
a dispersion medium having the first and second electrophoretic particles dispersed therein; and
a capsule enclosing the first and second electrophoretic particles and the dispersion medium.

3. The electrophoretic display of claim 1, wherein the electrophoretic member comprises:
electrophoretic particles having at least one of red, green, blue, yellow, magenta, or cyan colors;
a dispersion medium having the electrophoretic particles dispersed therein; and
a capsule enclosing the electrophoretic particles and the dispersion medium.

4. The electrophoretic display of claim 3, wherein the electrophoretic member further comprises additional electrophoretic particles that are dispersed in the dispersion medium and having a black color.

5. The electrophoretic display of claim 1, wherein the transfer film is an organic film having an ultraviolet hardener.

6. The electrophoretic display of claim 1, wherein the first electrode is a common electrode, and the second electrode is a pixel electrode.

7. A method for manufacturing an electrophoretic display, comprising:
forming a thermal conversion film on a transfer substrate;
forming a transfer film having an electrophoretic member dispersed therein on the thermal conversion film;
preparing a first panel where a first electrode is formed and aligning the first panel and a transfer substrate;
transferring a predetermined portion of the transfer film to the first electrode by a laser induced thermal imaging (LITI) method; and
preparing a second panel where a second electrode is formed to align and tightly contact the second panel and the transfer film so that the second electrode and the transferred transfer film can correspond to each other.

8. The method of claim 7, wherein the forming of the transfer film comprises:
coating a transfer film forming material having an electrophoretic member dispersed therein on the transfer substrate; and
hardening the coated transfer film forming material.

9. The method of claim 8, wherein the hardening of the predetermined transferred portion of the transfer film is performed by ultraviolet hardening.

10. The method of claim 7, wherein the predetermined transferred portion of the transfer film is hardened between the transferring of a predetermined portion of the transfer film to the first electrode and the preparing of a second panel.

11. The method of claim 10, wherein the hardening of the predetermined transferred portion of the transfer film is performed by ultraviolet hardening.

12. The method of claim 7, wherein the laser used in the laser induced thermal imaging (LITI) method is an infrared ray laser.

13. The method of claim 12, wherein the infrared ray laser has a wavelength from 760 nm to 1200 nm.

14. The method of claim 7, wherein the electrophoretic member comprises:
first electrophoretic particles having a white color;
second electrophoretic particles having a black color;
a dispersion medium having the first and second electrophoretic particles dispersed therein; and
a capsule enclosing the first and second electrophoretic particles and the dispersion medium.

15. The method of claim 7, wherein the electrophoretic member comprises:
electrophoretic particles having at least one of red, green, and blue, yellow, magenta, or cyan colors;
a dispersion medium having the electrophoretic particles dispersed therein; and
a capsule enclosing the electrophoretic particles and the dispersion medium.

16. The method of claim 15, wherein the electrophoretic member further comprises additional electrophoretic particles that are dispersed in the dispersion medium and having a black color.

17. The method of claim 15, wherein the transfer substrate comprises
first to third transfer substrates, and
the forming of the transfer film comprises:
forming a first transfer film on a thermal conversion film formed on the first transfer substrate, the first transfer film having an electrophoretic member including first electrophoretic particles having a red color dispersed and fixed thereon;
forming a second transfer film on a thermal conversion film formed on the second transfer substrate, the second transfer film having an electrophoretic member including first electrophoretic particles having a green color dispersed and fixed thereon; and
forming a third transfer film on a thermal conversion film formed on the third transfer substrate, the third transfer film having an electrophoretic member including third electrophoretic particles having a blue color dispersed and fixed thereon.

18. The method of claim 15, wherein the transfer substrate comprises
first to third transfer substrates, and
the forming of the transfer film comprises:
forming a first transfer film on a thermal conversion film formed on the first transfer substrate, the first transfer film having an electrophoretic member including first electrophoretic particles having a yellow color dispersed and fixed thereon;
forming a second transfer film on a thermal conversion film formed on the second transfer substrate, the second transfer film having an electrophoretic member including first electrophoretic particles having a magenta color dispersed and fixed thereon; and
forming a third transfer film on a thermal conversion film formed on the third transfer substrate, the third transfer film having an electrophoretic member including third electrophoretic particles having a cyan color dispersed and fixed thereon.

19. The method of claim 17, wherein the aligning of the transfer substrate and the first panel comprises:
aligning the first panel and the first transfer substrate;
aligning the first panel and the second transfer substrate; and
aligning the first panel and the third transfer substrate.

20. The method of claim 19, wherein the transferring of a predetermined portion of the transfer film to the first electrode comprises:
transferring a predetermined portion of the first transfer film to a corresponding portion of the first electrode;
transferring a predetermined portion of the second transfer film to a corresponding portion of the first electrode so as to be adjacent to the predetermined transferred portion of the first transfer film; and
transferring a predetermined portion of the second transfer film to a corresponding portion of the first electrode so as to be adjacent to the predetermined transferred portion of the second transfer film.

21. The method of claim 18, wherein the aligning of the transfer substrate and the first panel comprises:
aligning the first panel and the first transfer substrate;
aligning the first panel and the second transfer substrate; and
aligning the first panel and the third transfer substrate.

22. The method of claim 21, wherein the transferring of a predetermined portion of the transfer film to the first electrode comprises:
transferring a predetermined portion of the first transfer film to a corresponding portion of the first electrode;
transferring a predetermined portion of the second transfer film to a corresponding portion of the first electrode so as to be adjacent to the predetermined transferred portion of the first transfer film; and
transferring a predetermined portion of the second transfer film to a corresponding portion of the first electrode so as to be adjacent to the predetermined transferred portion of the second transfer film.

23. The method of claim 7, wherein the first electrode is a common electrode, and
the second electrode is a pixel electrode.

24. The method of claim 7, wherein the first electrode is a pixel electrode, and
the second electrode is a common electrode.
